(19) United States
(12) Patent Application Publication
(10) Pub. No.: US 2008/0258063 A1
(43) Pub. Date: Oct. 23, 2008

(54) Vehicle threat detection system

(76) Inventor: John Rapanotti, Quebec (CA)

Correspondence Address: GEORGE A. SEABY;SEABY & ASSOCIATES, 250 CITY CENTRE AVNUE, OTTAWA, ON, K1R6K7, CA

(21) Appl. No.: 11/785,969

(22) Filed: Apr. 23, 2007

(51) Int. Cl. G01V 8/00

(52) U.S. Cl. 250/334

(57) ABSTRACT

A threat detection system for a light armored vehicle utilizes dual-purpose optical systems, the primary functions of which are maneuvering the vehicle, targeting and surveillance. Initial detection of a threat can occur with a wide field of view optical system fixed to a main turret of the vehicle system, where a signal from the wide field of view determines the direction of a threat and is then used to slew a narrow field of view optical system towards the threat. The direction of the threat is then further defined and sent to a very narrow field of view sensor used primarily with laser illumination. The very narrow field of view sensor has sufficient spatial resolution to detect both the threat and a launch platform for countering the threat.

### BACKGROUND OF THE INVENTION

1. Field of the Invention

This invention relates to a vehicle threat detection system.

In particular, the invention relates to a system and procedures for improving the survivability of light armored vehicles and other military vehicles by detecting incoming projectiles and launch platforms.

2. Description of Related Art

Light armored vehicles meet the requirement for rapid deployment by replacing passive armor with sensors, computers and countermeasures to detect and avoid threats. The requirement for increased situational awareness on the battlefield is met by processing imagery from vehicle sensors. Based on analyses of vehicle operational requirements, sensors are needed to maneuver and drive the vehicle in chemically and biologically adverse environments including nighttime or reduced light conditions. Operating in these environments is achieved by isolating the crew from the environment, and providing starring array sensors mounted on a main vehicle turret. The starring array or hemispherical field of view provides a vehicle crew with a “glass turret” view of the battlefield. Additional vehicle operational requirements include targeting based on a thermal sight with a moderate optical power that can be slewed independently of the main vehicle turret and surveillance based on laser illumination and a range-gated camera to increase the level of contrast. Surveillance based on active imaging outside the visible spectrum can be conducted without being detected. These two optical systems can be housed together in a mini-turret.

Most threats to land vehicles rely on chemical propulsion and include guns with short duration, high intensity bursts of energy and rockets with low intensity, long burning propellant. In some missile systems, propellants burn cleanly to avoid interference with missile guidance but the products of combustion include significant amounts of hot water vapor, carbon dioxide and carbon monoxide radiating in precise rotational-vibrational bands. The more useful band centers include 2.7 μm for water and carbon dioxide, 4.3 μm for carbon dioxide and 4.67 μm for carbon monoxide. Plume temperatures can exceed 2000 K, but with entrainment of surrounding air the products of combustion rarely exceed 1600 K. Based on these factors, the mid-infrared range of 3-5 μm is chosen for detection of threats relying on chemical propulsion

### BRIEF SUMMARY OF THE INVENTION

Sensor cost in threat detection systems is an important consideration. An object of the present invention is to provide a threat detection system, which minimizes cost by utilizing dual-purpose sensors, the primary use of which is maneuvering and driving a vehicle, targeting and surveillance.

Another object of the invention is to provide a threat detection system, which is robust and relatively reliable because of sensor design based on different, complementary technologies, and which avoids catastrophic failure by the distribution of the sensors about a vehicle.

Yet another object of the invention is to provide a threat detection system in which information from individual sensors subsystems is communicated through a data bus to other vehicle resources such as a fire control system and to other vehicles in a network.

A threat detection system for a light armed vehicle in accordance with the invention comprises a plurality of first sensors defined by infrared starring arrays having a wide field of view at the periphery of a main turret of the vehicle to provide hemispherical threat detecting coverage of a field of view around the vehicle; a mini-turret on the vehicle; and a second, mid-infrared sensor having a narrow field of view on said mini-turret, wherein any signal from the wide field of view starring arrays will slew the narrow field of view sensor towards an area where the signal was detected.

### BRIEF DESCRIPTION OF THE DRAWINGS

FIG. 1 is a schematic isometric view of a vehicle and a threat detection system in accordance with the invention; and

FIG. 2 is a schematic side view of the scanning pattern of a narrow field of view array used in the system of FIG. 1.

### DETAILED DESCRIPTION OF THE INVENTION

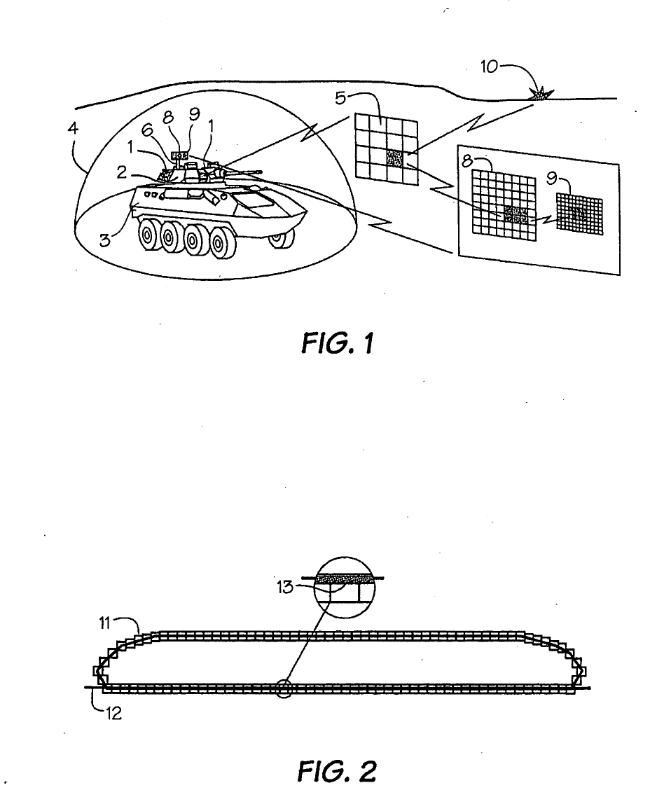

Referring to FIG. 1, a threat detection system in accordance with the present invention includes four wide field of view (WFOV) infrared starring arrays 1 mounted on the corners of the main turret 2 of a light armored vehicle 3. The arrays 1, which average 4096×4096 pixels, provide hemispherical coverage (indicated by the dome 4) at a relative low spatial resolution. At practical ranges, most threats have dimensions occupying less than one pixel 5.

A signal from the WFOV arrays 1 is used to slew, at a rate of 7200 a second, a mini-turret 6 carrying a narrow field of view (NFOV) mid-IR array 8 and a third optical device in the form of a camera 9. The NFOV array 8 is a mid-infrared 1024×1024 pixel array with a field of view of 2.50×2.5°. The camera 9 is a laser illuminated and range gated (LI/RG) camera based on a near-infrared, 0.8 μm, 1024×1024 pixel array with an even narrower field of view of 0.50×0.5°. The relationship between the NFOV array 8 and the camera 9 is fixed, and is used to refine the pointing direction and guide the camera 9 to the threat direction. The net result is that the combination of the three optical system are used in proper sequence to detect a threat 10, refining the threat direction progressively from hemispherical coverage to an instantaneous field of view of less than 10 μrad.

Optical detection performance requires all three optical systems. However, when the WFOV arrays 1 are not available or the infrared signal is too low, it is possible to use the mini-turret optics to scan for threats. Scanning is carried out for both land-based missile launches and in-flight missiles. Based on the 60 Hz frame rate of the NFOV array 8, a scanning pattern 11 (FIG. 2) is constructed from individual frames. The pattern and scan time are limited to about 2 seconds based on the boost phase of a typical anti-tank guided missile (ATGM). Therefore, a 1350 scan along the horizon 12, followed by a similar return scan of the sky at an elevation of 15° can be completed in less than 2 seconds.

The relationship 13 between the aiming of the two optical systems 8 and 9 on the mini-turret 6 is illustrated in FIG. 2. The field of view of the LI/RG camera 9 is contained in the NFOV of the IR system. During the horizon scan the camera is aimed at either the horizon or at a virtual point 5 km from the vehicle 3. Few direct-fire weapons have ranges exceeding 5 km. In complex or hilly terrain, initial threat detection can be carried out more efficiently by the WFOV arrays 1.

The threats to a vehicle rely on chemical propulsion either to deliver a warhead or to generate sufficient kinetic energy to damage or destroy the target. In general, threats to a vehicle 3 include anti-tank guided missiles (ATGMs), missiles or rounds from large-caliber guns (125 mm) including a chemical energy warhead and a kinetic energy penetrator, respectively, and rounds from smaller (30 mm) guns firing a 30 mm round or a 14.5 mm round, respectively. The side-discharged plumes from some missiles have small underexpanded flows and are therefore relatively difficult to detect. By contrast, the rocket exhaust from an ATGM is fully expanded resulting in larger plumes, which are detectable at longer ranges. Some missiles rely on launch, boost and flight motors to attain the necessary velocity, while other missiles are all-burnt-on-launch devices.

The table, which follows, provides distance at which named vehicle threats can first be detected by WFOV arrays 1 under favorable conditions. Detection of the threats by the NFOV array 8 under more adverse conditions and by the camera 9 is also provided in the table.

SEARCH AND TRACK PERFORMANCE

| | IR WFOV | IR NFOV | LI/RG Camera | | | |
|---|---|---|---|---|---|---|
| | 90° × 90° | 2.5° × 2.5° | 0.5° × 0.5° | | | |
| Anti-Armor | 4096 × 4096 | 1024 × 1024 | 1024 × 1024 | | Threat Variables | |
| Threat | Distance | Distance | Threat | Target | Range | Velocity |
| Type | m | m | pixels | pixels | m | m/s |
| MISSLE 25 | 400 | 3600 | 1.3 | 25 × 20 | 14000 | 255 |
| ATGM 26 | 4770 | 7740 | 79 | 90 × 30 | 4000 | 175 |
| ATGM 27 | 1640 | 3050 | 7 | 70 × 23 | 5000 | 255 |
| ATGM 28 | 3500 | 5400 | 254 | 235 × 78 | 1500 | 270 |
| ATGM 29 | 3180 | 3750 | 7 | 64 × 21 | 5500 | 210 |
| ATGM 30 | 9410 | 12200 | 200 | 94 × 31 | 3750 | 235 |
| RPG 31 | 470 | 4200 | 1385 | 234 × 187 | 500 | 255 |
| RPG 32 | 470 | 4200 | 531 | 146 × 117 | 800 | 300 |
| RPG 33 | 8600 | 1500 | 1075 | 586 × 469 | 200 | 95 |
| GUN 34 | 17200 | 3050 | 16 | 90 × 30 | 4000 | 775 |
| GUN 35 | 17200 | 700 | 4 | 118 × 60 | 2000 | 1450 |
| GUN 36 | 5480 | 700 | 4 | 118 × 60 | 2000 | 815 |
| GUN 37 | 5480 | 340 | 0.8 | 118 × 60 | 2000 | 815 |

The missile 25 is fired by artillery from as far away from the target vehicle as 14 km. The blast can be detected by the WFOV arrays 3 at the maximum range. The missile 25 can be detected by the NFOV array 8 at 3600 m then classified and tracked by the LI/RG camera 9 fourteen seconds from the vehicle 1. If the missile launch is not detected, the missile can still be detected by an IRST scan. Detection is also possible by the WFOV arrays 3 at 400 m, 1.5 s from the vehicle.

The anti-tank missiles (ATGMs) 26 to 30 are guided to the target. To avoid interference with missile guidance a clean-burning propellant is used and the rocket exhaust is diverted through two nozzles on either side of the missiles. Detection of these missiles depends primarily on detection of the exhaust plumes, by using infrared sensors, at ranges up to 5500 m.

ATGM 26 is a missile relying on wire guidance to correct the flight path relative to an infrared beacon at the back of the missile, but can be guided manually if jamming is suspected. A boost motor increases the velocity to about 108 m/s and a maximum range of 4000 m is achieved in about 19 s. A newer version of this missile allows the operator to switch to a manual mode if optical jamming is detected. The missile can be detected by the NFOV array 8 at any practical range from the vehicle and by the WFOV arrays 1 by 900 m, 5 s from the vehicle.

ATGM 27 is a missile launched from a 125 mm tank gun and guided to the target by laser. The missile 27 is a laser-beam rider launched from the tank gun. The maximum range is 500 m. Detected by the initial blast, the missile 27 can be tracked by the LI/RG camera 9 over the full range. The missile 27 can also be detected by NFOV array 8 by 3050 m, 12 s from the vehicle 3 and by the WFOV arrays 1 by 330 m, 1.3 s from the vehicle.

ATGM 28 is a wire-guided missile using a pyrotechnic flare as an infrared beacon. The boost velocity is 200 m/s and the maximum range is about 1500 m. The missile is susceptible to countermeasures including false beacons and wide-area active smoke. It can be detected by the NFOV array 8 at any practical range from the vehicle 3 and with the WFOV arrays 1 by 600 m, 3.5 s from the vehicle 3.

The ATGM 29 is a missile relying on a laser signal to guide the missile over a maximum range of 5500 m. The boost velocity is estimated to be 225 m/s. It can be detected by the NFOV array 8 by 3750 m, 18 s from the vehicle and by the WFOV arrays 1 by 400 m, 1.9 s from the vehicle 3.

ATGM 30 is a missile relying on a xenon beacon for guidance to the target, and therefore, is not susceptible to false beacon jamming. The missile can be susceptible to wide-area active smoke if the intensity is sufficiently high and noisy. The missile 30 can be detected by the NFOV array 8 at any range from the vehicle 3 and by the WFOV arrays 1 by 1360 m, 5.8 s from the vehicle 3 while under boost or with the reduced intensity level in post burnout flight by 400 m, 1.7 s from the vehicle, with the WFOV arrays 1.

Rocket propelled grenade (RPG) 31 is a generic rocket propelled grenade with a typically short range and high subsonic velocity sustained over the entire flight. The destructive power is produced by a shaped-charge warhead. It can be detected by the NFOV array 8 at any range and with WFOV arrays 1 by 500 m, 1.0 s from the vehicle 3. Scanning the battlefield with the LI/RF camera 9 on active will also detect the shooter through retroreflection.

RPG 32 is similar to RPG 31 above but a smaller caliber. The range is also longer at 800 m. It can be detected by NFOV array 8 at any range and with WFOV arrays 1 by 500 m, 1.0 s from the vehicle.

The RPG 33, unlike the other two RPGs, is based on a propellant designed to burn completely during launch. The grenade launch produces a high intensity short duration flash that is easily by the WFOV arrays 1. The grenade itself can be detected by the NFOV array 8 at the maximum range of 200 m. With an average velocity of 95 m/s, the flight time is 2.1 s.

Gun round 34 is a 125 mm caliber, high energy, anti-tank (HEAT) round. The blast can easily be detected by the WFOV arrays 1. The projectile can also be detected by the NFOV array 8 at 3050 m, 4 s from the vehicle 3. The LI/RG camera 9 can be used to track the round over the full range. The projectile can also be detected by NFOV array 8 3050 m, 4 s from the vehicle 3.

Gun round 35 is a 125 mm caliber armor-piercing fin-stabilized discarding sabot (ADFSDS) round. The NFOV array 8 and the camera 9 can be used to provide more precise information for a hard-kill system.

Gun round 36 is a 30 mm round. Detection of the blast by the WFOV array 1 can be used to slew the NFOV array 8 and the projectile is then tracked by the camera 9.

Gun round 37 is a 30 mm armor-piercing discarding sabot (APDS) round. The difference is that the subbore projectile is smaller and therefore more difficult to track.

1. A threat detection system for a light armored vehicle comprising a plurality of first sensors having a wide field of view at the periphery of a main turret of the vehicle to provide hemispherical threat detecting coverage of a field of view around the vehicle; a mini-turret on the vehicle; and a second, mid-infrared sensor having a narrow field of view on said mini-turret, wherein any signal from the wide field of view sensors will slew the narrow field of view sensor towards an area where the signal was detected.

2. The threat detection system of claim 1, wherein each of said first infrared sensors is a starring array having 4096×4096 pixels and the second, mid-infrared sensor has a narrow field of view of 1024×1024 pixel array with a 2.50×2.50 field of view.

3. The detection system of claim 2 including a laser illuminator and range-gated camera on the mini turret, the camera having a near infrared, 0.8 μm, 1024×1024 pixel array with a field of view of 0.50×0.5° directed to an area within the narrow field of view of the mid-infrared sensor.

4. The detection system of claim 1, wherein the mini-turret is located on the main turret and has a slew rate of 720°/sec.

5. The threat detection system of claim 2, wherein the mini-turret is located on the main turret and has a slew rate of 720°/sec.

6. The threat detection system of claim 3, wherein the mini-turret is located on the main turret and has a slew rate of 720°/sec.
